(19) United States
(12) Patent Application Publication
(10) Pub. No.: US 2025/0119897 A1
(43) Pub. Date: Apr. 10, 2025

(54) DATA TRANSMISSION METHOD AND APPARATUS, STORAGE MEDIUM, ELECTRONIC DEVICE, AND PRODUCT

(71) Applicant: TENCENT TECHNOLOGY (SHENZHEN) COMPANY LIMITED, Shenzhen (CN)

(72) Inventors: Yixue LEI, Shenzhen (CN); Yuhang JIA, Shenzhen (CN); Yong YANG, Shenzhen (CN)

(73) Assignee: TENCENT TECHNOLOGY (SHENZHEN) COMPANY LIMITED, Shenzhen (CN)

(21) Appl. No.: 18/983,682

(22) Filed: Dec. 17, 2024

Related U.S. Application Data
(63) Continuation of application No. PCT/CN2023/104785, filed on Jun. 30, 2023.

(30) Foreign Application Priority Data
Sep. 30, 2022 (CN) 202211230339.1

(51) Int. Cl. H04W 72/12; H04W 72/543; H04W 76/12

(52) U.S. Cl. CPC H04W 72/12; H04W 72/543; H04W 76/12

(57) ABSTRACT

A data transmission method, executed by an electronic device, includes: receiving periodicity information of a service data packet transmitted by an application object entity; configuring the periodicity information for an access network-network element by using a configuration instruction; receiving first indication information transmitted by the application object entity; and transmitting deactivation information to the access network-network element, wherein the first indication information indicates the periodicity information changes, and wherein the deactivation information indicates the access network-network element is to suspend scheduled transmission of the service data packet based on the periodicity information.

### CROSS-REFERENCE TO RELATED APPLICATIONS

This application is a continuation application of International Application No. PCT/CN2023/104785 filed on Jun. 30, 2023, which claims priority to Chinese Patent Application No. 202211230339.1, filed with the China National Intellectual Property Administration on Sep. 30, 2022, the disclosures of each being incorporated by reference herein in their entireties.

### FIELD

The disclosure relates to the field of computer and communication technologies, and more particularly, to a data transmission method and apparatus, a storage medium, an electronic device, and a product.

### BACKGROUND

In a 5G system and an evolved 5G system, a high-bandwidth interactive service is an important service type, such as cloud gaming, virtual reality (VR), augmented reality (AR), mixed reality (MR), extended reality (XR), and cinematic reality (CR).

These interactive service data packets generally have periodicity during transmission. A wireless network may use the periodicity to improve usage efficiency of time-frequency resources by using a semi-persistent scheduling (SPS) or connected-discontinuous reception (C-DRX) mechanism.

However, the periodicity of the service data packets may change. Therefore, how to deal with this change and avoid affecting service experience is an urgent technical problem that needs to be resolved.

### SUMMARY

Provided are a data transmission method and apparatus, a storage medium, an electronic device, and a product such that, based on periodicity information of a service data packet changing, an access network-network element may suspend scheduled transmission of the service data packet based on the periodicity information of the service data packet in time; which may avoid a problem of quality of service (QOS) deterioration caused when the access network-network element continues to perform scheduled transmission based on the previous periodicity information and may improve service experience.

According to some embodiments a data transmission method, performed by an electronic device, includes: receiving periodicity information of a service data packet transmitted by an application object entity; configuring the periodicity information for an access network-network element by using a configuration instruction; receiving first indication information transmitted by the application object entity; and transmitting deactivation information to the access network-network element, wherein the first indication information indicates the periodicity information changes, and wherein the deactivation information indicates the access network-network element is to suspend scheduled transmission of the service data packet based on the periodicity information.

According to some embodiments, a data transmission apparatus includes: at least one memory configured to store computer program code; at least one processor configured to read the program code and operate as instructed by the program code, the program code comprising: obtaining code configured to cause at least one of the at least one processor to receive periodicity information of a service data packet transmitted by an application object entity; configuration code configured to cause at least one of the at least one processor to configure the periodicity information for an access network-network element by using a configuration instruction; receiving code configured to cause at least one of the at least one processor to receive first indication information transmitted by the application object entity; and transmitting code configured to cause at least one of the at least one processor to transmit deactivation information to the access network-network element, wherein the first indication information indicates the periodicity information changes, and wherein the deactivation indicates the access network-network element is to suspend scheduled transmission of the service data packet based on the periodicity information.

According to some embodiments, a non-transitory computer-readable storage medium, storing computer code which, when executed by at least one processor, causes the at least one processor to at least: receive periodicity information of a service data packet transmitted by an application object entity; configure the periodicity information for an access network-network element by using a configuration instruction; receive first indication information transmitted by the application object entity; and transmit deactivation information to the access network-network element, wherein the first indication information indicates the periodicity information changes, and wherein the deactivation indicates the access network-network element is to suspend scheduled transmission of the service data packet based on the periodicity information

The foregoing and following descriptions are illustrative and explanatory, and the disclosure is not limited thereto.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an exemplary system architecture according to some embodiments.

FIG. 2 is a schematic diagram of a transmission process of a multimedia data packet according to some embodiments.

FIG. 3 is a schematic diagram of a system architecture of a data transmission method according to some embodiments.

FIG. 4 is a schematic diagram of delay jitter distribution comparison of a transmission process of a service data packet according to some embodiments.

FIG. 5 is a flowchart of a data transmission method according to some embodiments.

FIG. 6 is a flowchart of a data transmission method according to some embodiments.

FIG. 7 is a flowchart of a data transmission method according to some embodiments.

FIG. 8 is a flowchart of a data transmission method according to some embodiments.

FIG. 9 is an interactive flowchart of a data transmission method according to some embodiments.

FIG. 10 is an interactive flowchart of a data transmission method according to some embodiments.

FIG. 11 is a block diagram of a data transmission apparatus according to some embodiments.

FIG. 12 is a block diagram of a data transmission apparatus according to some embodiments.

FIG. 13 is a schematic diagram of a structure of an electronic according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Block diagrams shown in the figures are functional entities and do not necessarily correspond to physically separate entities. These functional entities may be implemented in a form of software, or these functional entities may be implemented in one or more hardware modules or integrated circuits, or these functional entities may be implemented in different networks and/or processor apparatuses and/or microcontroller apparatuses.

Flowcharts shown in the drawings are examples and are not necessarily executed in a described sequence. For example, some operations/steps may also be decomposed, and some operations/steps may be merged or partially merged, so an actual sequence of execution may change based on an actual situation.

The “plurality” mentioned in this disclosure refers to two or more. The term “and/or” is an association relationship for describing associated objects, and represents that three relationships may exist. For example, A and/or B may represent the following three cases: Only A exists, both A and B exist, and only B exists. A and/or B may represent the following three cases: Only A exists, both A and B exist, and only B exists.

With the development of 5th-generation mobile generation technology (5G), a plurality of multimedia services that use a large amount of data and a short delay are applied, for example, a cloud gaming service and interactive services such as VR, AR, MR, XR, and CR.

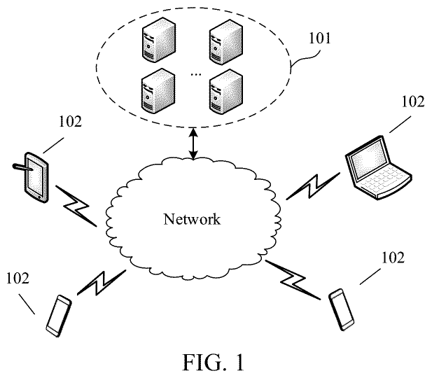

In a cloud gaming scenario shown in FIG. 1, a cloud server 101 may be configured to run cloud gaming. The cloud server 101 may render a game image, encode an audio signal and a rendered image, and finally transmit encoded data obtained through encoding to each game client through a network.

The game client may be user equipment (UE) 102 having a streaming media playback capability, a human-computer interaction capability, a communication capability, and the like, for example, a smart phone, a tablet computer, a laptop computer, a desktop computer, a smart television, a smart appliance, an on board terminal, and an aircraft. The game client may be an application running in a terminal device 102. The game client may decode the encoded data transmitted by the cloud server 101, to obtain a stimulated audio and video signal, and play the stimulated audio and video signal.

FIG. 1 is an example system architecture that represents a cloud gaming system, and does not limit a system architecture of the cloud gaming system. For example, in some embodiments, the cloud gaming system may further include a back-end server for scheduling, and the like. In addition, the cloud server 101 may be an independent physical server, or a server cluster or a distributed system composed of a plurality of physical servers, or may be a cloud server that provides a cloud service, a cloud database, cloud computing, a cloud function, cloud storage, a network service, cloud communication, a middleware service, a domain name service, a security service, a content delivery network (CDN), and a cloud computing service such as big data and an artificial intelligence platform. The game client and the cloud server 101 may be connected directly or indirectly in a wired or wireless communication protocol, but the disclosure is not limited thereto.

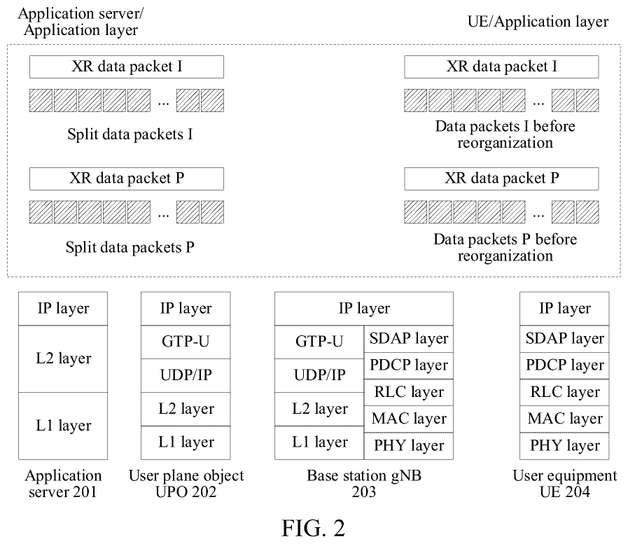

In an interactive service application scenario based on the multimedia, because a multimedia data packet may be large, the multimedia data packet may be split into a plurality of data packets for transmission during transmission. As shown in FIG. 2, in the 5G system, a user plane may include an application server 201, a user plane object (UPO) (sometimes referred to as a “user plane function” (UPF) by the 3rd Generation Partnership Project (3GPP), for example) 202, a base station (next generation NodeB, gNB) 203, and UE 204.

For some service scenarios, transmission of the multimedia data packet may be in a downlink direction, for example, from the application server to the UPO, and the multimedia data packet may be sent to the UE through the gNB. During transmission, the multimedia data packet (for example, an XR data packet in FIG. 2) is split in an application layer of the application server. Based on split data packets as IP packets being transmitted from the application server to the UPO, the 5G system transmits sub data packets to a UE end by using a protocol data session (sometimes referred to as a “protocol data unit” (PDU) by the 3GPP, for example) session, submits and reorganizes the multimedia data packets from a protocol stack to recover the multimedia data packets in the UE end.

In the system in FIG. 2, an L1 layer is a physical layer, and may be configured such that that original data may be transmitted on various physical media; an L2 layer is a data link layer, and the data link layer provides a service to a network layer based on a service provided by the physical layer; an internet protocol (IP) layer is the network layer, and may be configured to implement data transmission between two end systems; a UDP is a user datagram protocol; a GTP-U is a general packet radio service (GPRS) tunneling protocol-user plane; the PHY is the physical layer; a MAC is a media access control; an RLC is a radio link control protocol; a PDCP is a packet data convergence protocol; and an SDAP is a service data adaptation protocol.

For the multimedia service, such as an XR and media (XRM) service, a frame of a multimedia data packet may be split into a plurality of data packets for transmission. A data packet formed by a single multimedia service frame may also have large quantity of bytes, and may be carried by a series of internet protocol (IP) data packets. There may be a correlation between these IP data packets, and a wireless network bandwidth may be saved by processing these packets based on the correlation.

A part of an XRM service flow has periodicity, such as a data packet is generated based on 60/90/120 frames per second (FPS), and a generated video frame may generate the data packet based on a time interval of 16.67 ms/11.11 ms/8.33 ms.

By using these periodicity characteristics, a wireless network may improve usage efficiency of time-frequency resources, for example, by using a semi-persistent scheduling (SPS) or connected-discontinuous reception (C-DRX) mechanism based on the periodicity of the XRM service. However, a premise for using this method is that the 5G system has learned that the XRM service flow has the periodicity.

The C-DRX in some embodiments is the connected-discontinuous reception mode. This may make the UE enter a sleep state periodically without detecting a physical downlink control channel (PDCCH), may wake up the UE from the sleep state when detection is to be used, and power saving may be achieved.

In some embodiments, an application object (AO) (sometimes referred to as an “application function” (AF) by the 3GPP, for example)/application server (AS) may directly provide periodicity information and a delay jitter distribution characteristic of the service flow for the 5G system (5GS). The multimedia service having the periodicity may always have constant periodicity during transmission in the 5G system. The base station may perform C-DRX configuration based on the periodicity and the delay jitter distribution characteristic of the data packet. In a process of real-time streaming media transmission, because of impact of computing power or a network condition, the application layer may adjust the periodicity of the service data packet based on performing adaptation, or in a transmission process from the AO/AS to the gNB, and the periodicity may be affected. Assuming that the service data packet has the constant periodicity may not always be valid.

A demand for a computing power service on a bearer network may be reflected in an ultra-large bandwidth, a low delay, and high reliability, security, and flexibility.

In some embodiments, in a process of protocol data session establishment or QoS flow configuration, a periodicity parameter of an application layer service flow may be set. However, in a transmission process of data packets of the multimedia service such as the XR, configured periodicity is allowed to be activated and deactivated based on a detected periodic change.

In some embodiments, based on the periodicity being activated, a radio access network (RAN) side may configure a C-DRX period based on an end-to-end protocol data session and a QoS flow parameter, to implement power-saving transmission. Based on the periodicity being deactivated, C-DRX transmission is suspended, and a related core network (CN) network element and a related C-DRX parameter of a RAN node may not be deleted. The parameter may not be re-established in an activation process.

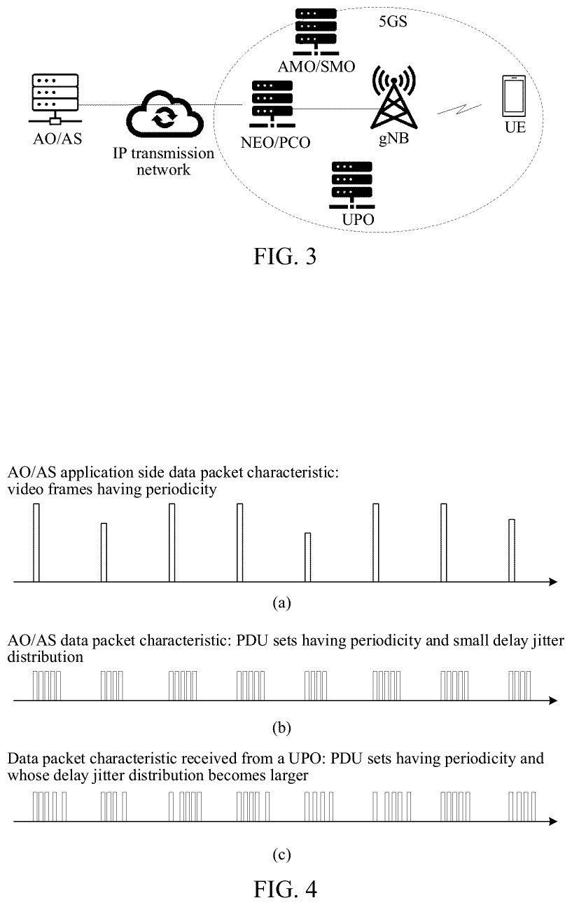

As shown in FIG. 3, the AO/AS may implement a control plane object (sometimes referred to as a “control plane function”) of a third party application server, and may implement interaction in an AO-network exposure object (NEO) (sometimes referred to as a “network exposure function” (NEF) by the 3GPP, for example)-policy control object (PCO) (sometimes referred to as a “policy control function” (PCF) by the 3GPP, for example) manner or an AO-PCO manner. The AO/AS entity may implement a user plane function of the third party application server, for example, AS-IP transmission network-UPO interface.

In a system architecture shown in FIG. 3, a 5GS gateway may be the UPO, or may be an entity responsible for capability opening on the control plane, such as the NEO, the PCO, or a router/switch node deployed between the 5GS and an external network.

The IP transmission network in some embodiments may be implemented in a wired or wireless manner, for example, based on a metropolitan area network, an access network, or a wide area network of an optical network depending on a topological relationship between a 5G core (5GC) network boundary and the third party application server. Because the 5G network uses a network architecture beneficial to UPO sinking, and if the AO/AS is located at an edge, and the UPO sinks to this edge location, a topological distance between the 5GC boundary (for example, the UPO at the edge location) and the AO/AS is shortened. However, the AO/AS may be located at a center cloud. In this situation, UPO sinking cannot solve this problem. Impact of the IP transmission network on the service flow transmission between a third party server and the 5GC boundary, for example, the UPO, may not be ignored.

As shown in FIG. 4 (a), an AO/AS application side data packet characteristic may be, for example, a video frame having periodicity; as shown in FIG. 4 (b), during transmission, the video frame may be split into a plurality of IP data packets for transmission, where the plurality of IP data packets may form a protocol data set, and delay jitter distribution of the IP data packets is small.

Because these IP data packets may be transmitted between the third party server AS and the 5GS gateway, based on the IP data packets being transmitted to the UPO, the delay jitter distribution of the IP data packets may become larger, and may have impact on the periodicity of the IP data packets. As shown in FIG. 4 (c), a delay between IP data packets in one protocol data set becomes larger, and this causes longer time for receiving one protocol data set, and affects the periodicity of the IP data packets. If the periodicity of the IP data packets changes, the C-DRX configuration at the RAN side cannot be adapted, which may cause QoS deterioration.

To avoid the QoS deterioration caused based on the periodicity of the IP data packets changing, in some embodiments, for the multimedia service (such as an XR service of a preset frame rate) having the periodicity, the periodicity may be transferred from the AO to the 5GC as a reference for the protocol data session establishment or the QoS flow parameter configuration. For example, in a process of the protocol data session establishment or the QoS flow parameter configuration, the periodicity may be configured to the gNB.

In addition, a factor that affects periodicity of a pushing stream due to the computing power and the network condition in the multimedia data stream transmission may be considered, and the periodicity parameter configured for the gNB may be deactivated for partial period of time. During the deactivation, the periodicity parameter may be retained in a 5GC-related network element and the gNB, and a gNB side suspends to perform C-DRX configuration based on the periodicity.

Based on detecting that the periodicity is stable (or the periodicity is regained), the AO/AS may activate the configured periodicity parameter, and continue to perform C-DRX configuration. The periodicity of the service data packets may be stable in the C-DRX, and a QoS condition may be satisfied. This may improve service experience.

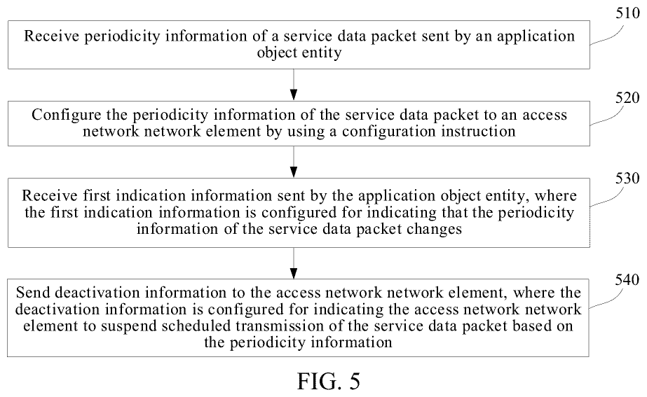

FIG. 5 is a flowchart of a data transmission method according to some embodiments. The data transmission method may be executed by an electronic device corresponding to a core network-network element, for example, may be executed by a PCO. Refer to FIG. 5. The data transmission method may include 510 to 540.

Operation 510: Receive periodicity information of a service data packet sent by an application function entity.

In some embodiments, based on determining the periodicity information of the service data packet, an AO may directly send the periodicity information of the service data packet to the PCO, or the AO first sends the periodicity information to an NEO, and the NEO forwards the periodicity information to the PCO.

In this operation, the periodicity information refers to whether the service data packet has periodicity, or whether the service data packet is generated periodically. Based on determining the service data packet has the periodicity, the periodicity information may further include a periodicity parameter of the service data packet, including a value of a period in which the service data packet is generated.

The periodicity information may also indicate whether a service flow of the service data packet has the periodicity.

In some embodiments, the AO may determine the periodicity information of the service data packet based on at least one factor: an encoding and decoding mode of the service data packet; a multimedia service flow transmission parameter corresponding to the service data packet; a pushing parameter of an application server for the multimedia service flow; and a pulling parameter of the application server for the multimedia service flow.

In some embodiments, the encoding and decoding mode of the service data packet, for example, may be one of advanced video coding (AVC), high efficiency video coding (HEVC), versatile video coding (VVC), or the like. Whether the service data packet is obtained based on the period may be determined based on the encoding and decoding mode of the service data packet. Whether the service data packet is generated periodically may be determined.

In some embodiments, the multimedia service flow transmission parameter corresponding to the service data packet may include service data content included in the service data packet, for example, one or more of an audio, a video, haptic, or the like. Whether the service data packet is generated periodically may be determined based on the service data content included in the service data packet.

In some embodiments, the pushing parameter of an application server for the multimedia service flow may be a pushing frame rate (such as a fixed frame rate or a variable frame rate), and the pulling parameter of the application server for the multimedia service flow may be a pulling frame rate (where the pulling frame rate may also be the fixed frame rate or the variable frame rate). The frame rate, including the fixed frame rate or the variable frame rate, may be the periodicity parameter, included in the periodicity information.

Operation 520: Configure the periodicity information of the service data packet for an access network-network element by using a configuration instruction.

In some embodiments, the configuration instruction may be configured for the access network-network element by using a protocol data session establishment request or QoS flow configuration information. The protocol data session establishment request or the QoS flow configuration information may be generated, where the protocol data session establishment request or the QoS flow configuration information include the periodicity information of the service data packet. A protocol data session establishment process is initiated based on the protocol data session establishment request, or a QoS flow configuration process is performed based on the QoS flow configuration information, to configure the periodicity information of the service data packet for the access network-network element. In some embodiments, the access network-network element may be a gNB.

In some embodiments, the configuration instruction may further instruct that the access network-network element directly performs scheduled transmission on the service data packet based on the periodicity information after receiving the configuration instruction. In some embodiments, the periodicity information of the service data packet is valid by default based on the configuration.

Operation 530: Receive first indication information sent by the application object entity, where the first indication information may be configured for indicating that the periodicity information of the service data packet changes.

In some embodiments, if the application object entity determines, by detecting a factor that affects periodicity of a pushing stream due to computing power and a network condition in a transmission process of the service data packet, that the periodicity information of the service data packet changes; and may send the first indication information to a core network-network element (such as the PCO). In some embodiments, the first indication information may be directly sent to the PCO by the AO, or the AO may first send the first indication information to an NEO, and the NEO forwards the first indication information to the PCO.

Operation 540: Send deactivation information to the access network-network element, where the deactivation information may be configured for indicating the access network-network element to suspend scheduled transmission of the service data packet based on the periodicity information.

In some embodiments, the configuration instruction configured to configure the periodicity information of the service data packet for the access network-network element may further include an indication parameter, where the indication parameter may be configured to indicate to activate or deactivate the periodicity information of the service data packet.

If the periodicity information of the service data packet is valid by default based on the configuration, the indication parameter of the configuration instruction may be configured to indicate to activate the periodicity information by default. If the PCO receives the first indication information, the sent deactivation information may be configured for modifying the indication parameter, so that the indication parameter indicates to deactivate the periodicity information of the service data packet.

In some embodiments, based on the periodicity information of the service data packet being deactivated, the core network-network element (such as a session management object (SMO) (sometimes referred to as a “session management function” (SMF) by the 3GPP, for example), and an access and mobility management object (AMO) (sometimes referred to as an “access and mobility management function” (AMF) by the 3GPP, for example) and the access network-network element (such as the gNB) may retain a C-DRX configuration parameter. The parameters may not be established again based on the periodicity being subsequently activated. In some embodiments, the indication parameter in some embodiments may be an explicitly indicated parameter or an implicitly indicated parameter.

In some embodiments, based on sending the deactivation information to the access network-network element, if second indication information sent by the application object entity based on detecting that the periodicity of the service data packet is stable (or the periodicity is regained) is received, the core network-network element (such as the PCO) sends activation information to the access network-network element. The activation information indicates that the access network-network element performs scheduled transmission on the service data packet based on the periodicity information. In some embodiments, the activation information may be configured for modifying the indication parameter configured by the configuration instruction, so that the indication parameter indicates to activate the periodicity information of the service data packet.

In some embodiments, based on detecting that a periodic change range of the service data packet is in a preset range, the application object entity may determine that the periodicity information of the service data packet is stable (or the periodicity is regained) and may send the second indication information to the core network-network element. The second indication information may be directly sent to the PCO by the AO, or the AO may first send the second indication information to the NEO, and the NEO forwards the second indication information to the PCO.

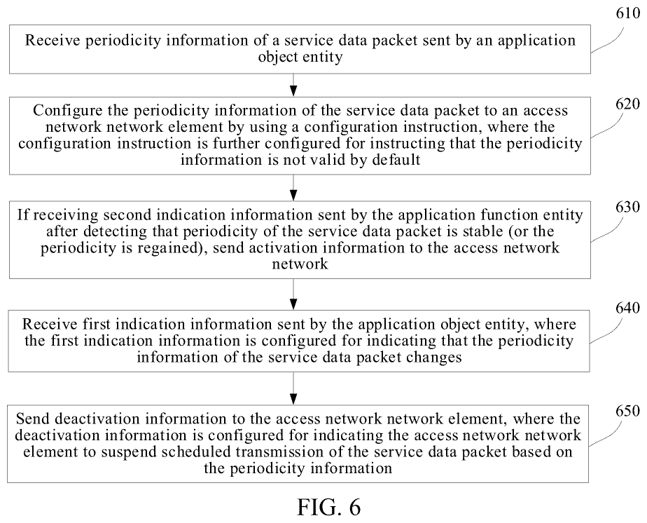

FIG. 6 is a flowchart of a data transmission method according to some embodiments. The data transmission method may be executed by a core network-network element, for example, may be executed by a PCO. Refer to FIG. 6. The data transmission method may include 610 to 650.

Operation 610: Receive periodicity information of a service data packet sent by an application object entity.

In some embodiments, refer to the description of operation 510.

Operation 620: Configure the periodicity information of the service data packet for an access network-network element by using a configuration instruction, where the configuration instruction is further configured for instructing that the periodicity information is not valid by default.

Because the configuration instruction is further configured for instructing that the periodicity information is not valid by default, an access network-network element suspends scheduled transmission of the service data packet based on the periodicity information after receiving the configuration instruction, and if not receiving activation information.

In some embodiments, the configuration instruction configured to configure the periodicity information of the service data packet for the access network-network element may further include an indication parameter, where the indication parameter may be configured to indicate to activate or deactivate the periodicity information of the service data packet. If the periodicity information of the service data packet is not valid by default based on the configuration, the indication parameter of the configuration instruction may be configured to indicate not to deactivate the periodicity information.

Operation 630: If receiving second indication information sent by the application object entity after detecting that periodicity of the service data packet is stable (or the periodicity is regained), send the activation information to the access network-network element.

In some embodiments, based on detecting that a periodic change range of the service data packet is in a preset range, the application object entity may determine that the periodicity information of the service data packet is stable (or the periodicity is regained), and may send the second indication information to the core network-network element. The second indication information may be directly sent to a PCO by an AO, or the AO may first send the second indication information to an NEO, and the NEO forwards the second indication information to the PCO. In some embodiments, the activation information may be configured for modifying the indication parameter configured by the configuration instruction, so that the indication parameter indicates to activate the periodicity information of the service data packet.

Operation 640: Receive first indication information sent by the application object entity, where the first indication information may be configured for indicating that the periodicity information of the service data packet changes.

Operation 650: Send deactivation information to the access network-network element, where the deactivation information may be configured for indicating the access network-network element to suspend the scheduled transmission of the service data packet based on the periodicity information.

For the description of operation 640 and operation 650, refer to the description of operation 530 and operation 540.

FIG. 5 and FIG. 6 describe some embodiments from a perspective of the core network-network element. Some embodiments are described below from a perspective of the application object entity.

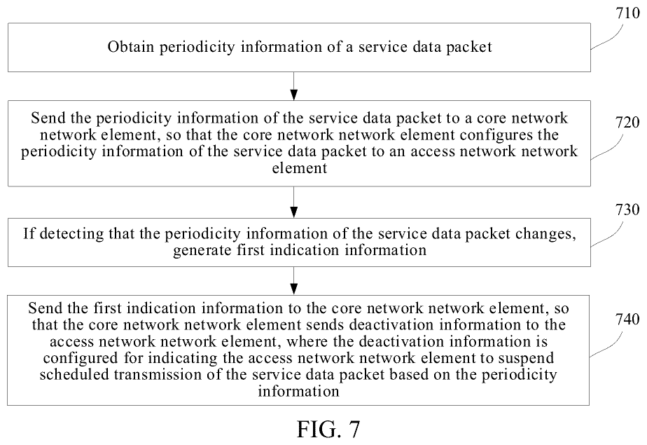

FIG. 7 is a flowchart of a data transmission method according to some embodiments. The data transmission method may be executed by an electronic device corresponding to an application object entity. Refer to FIG. 7. The data transmission method may include 710 to 740.

Operation 710: Obtain periodicity information of a service data packet.

In some embodiments, the AO may determine the periodicity information of the service data packet based on at least one factor: an encoding and decoding mode of the service data packet; a multimedia service flow transmission parameter corresponding to the service data packet; a pushing parameter of an application server for the multimedia service flow; and a pulling parameter of the application server for the multimedia service flow.

Operation 720: Send the periodicity information of the service data packet to a core network-network element, so that the core network-network element configures the periodicity information of the service data packet for the access network-network element.

In some embodiments, based on determining the periodicity information of the service data packet, the AO may directly send the periodicity information of the service data packet to the PCO, or the AO first sends the periodicity information to an NEO, and the NEO forwards the periodicity information to the PCO. A process where the core network-network element configures the periodicity information of the service data packet for the access network-network element may refer to the foregoing descriptions.

Operation 730: If detecting that the periodicity information of the service data packet changes, generate first indication information.

In some embodiments, the application object entity may determine, by detecting a factor that affects periodicity of a pushing stream due to computing power and a network condition in a transmission process of the service data packet, that the periodicity information of the service data packet changes. For example, if detecting that a periodic change range of the service data packet is greater than a preset value, such as a preset range, it is determined that the periodicity information of the service data packet changes.

Operation 740: Send the first indication information to the core network-network element, so that the core network-network element sends deactivation information to the access network-network element, where the deactivation information may be configured for indicating the access network-network element to suspend scheduled transmission of the service data packet based on the periodicity information.

In some embodiments, a process that the core network-network element sends the deactivation information to the access network-network element may refer to the foregoing descriptions.

In some embodiments, if detecting that the periodicity of the service data packet is stable, or tends to be stable, or the periodicity is regained, the AO may generate second indication information, and send the second indication information to the core network-network element, so that the core network-network element sends the activation information to the access network-network element. The activation information indicates that the access network-network element performs scheduled transmission on the service data packet based on the periodicity information.

In some embodiments, based on detecting that a periodic change range of the service data packet is in a preset range, the application object entity may determine that the periodicity information of the service data packet is stable (or the periodicity is regained), and may send the second indication information to the core network-network element.

The foregoing describes some embodiments from a perspective of the core network-network element and the application object entity. Some embodiments are further described from a perspective of interaction between a plurality of device entities.

The multimedia service may have the periodicity. The periodicity may be transferred from the AO to 5GC as a reference for protocol data session establishment or QoS flow parameter configuration. For example, in a process of the protocol data session establishment or the QoS flow parameter configuration, the periodicity may be configured to a gNB.

A factor that affects periodicity of a pushing stream due to the computing power and the network condition in the multimedia data stream transmission is considered, and the periodicity information configured for the gNB may be deactivated for partial period of time. During the deactivation, the periodicity information may be retained in a 5GC-related network element, and a gNB side suspends to perform C-DRX configuration based on the periodicity information. Based on detecting that the periodicity is stable (or the periodicity is regained), the AO/AS may activate the configured periodicity information, and continue to perform C-DRX configuration. The periodicity of the service data packets may be stable in the C-DRX, and a QoS condition may be satisfied. This may improve service experience.

The service data packet in some embodiments may be an XR service data packet, and may also be another data packet of the multimedia service, such as a data packet of a cloud gaming service, and data packets of services such as VR, AR, MR, and CR. Some embodiments may be applied to a process of the XR service data packet, and may also be applied to process the data packets of the services such as the cloud gaming, the VR, the AR, the MR, and the CR.

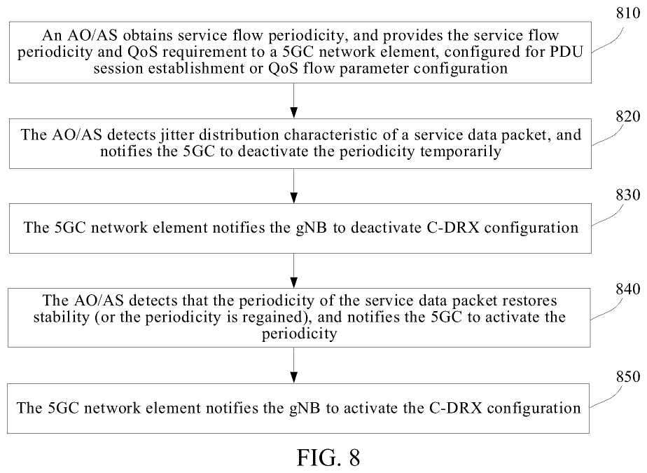

FIG. 8 is a flowchart of a data transmission method according to some embodiments, including the following operations.

Operation 810: An AO/AS obtains periodicity information of a service data packet, for example, service flow periodicity, and provides the periodicity information and QoS condition to a 5GC network element, configured for protocol data session establishment or QoS flow parameter configuration.

In some embodiments, an application layer pushing stream end may directly obtain a parameter of video content from the video content, including a frame rate, to obtain the periodicity information of the service data packet. For an XR multimedia video stream such as real-time live streaming, the periodicity information may also be determined by the application layer through detection. For example, the periodicity information is determined based on at least one parameters: an encoding and decoding mode of the service data packet; a multimedia service flow transmission parameter corresponding to the service data packet; a pushing parameter of an application server for the multimedia service flow; and a pulling parameter of the application server for the multimedia service flow.

In some embodiments, before a protocol data session is established, the service flow periodicity obtained by the application layer may be transferred from the AO to a 5GC, and may be a reference to the protocol data session establishment or the QoS flow parameter configuration.

In addition, a factor that affects periodicity of a pushing stream due to the computing power and the network condition in the multimedia data stream transmission is considered in, and the periodicity parameter configured for the gNB may be deactivated for partial period of time.

In configuration, a current protocol data session establishment request may be enhanced, the 5GC network element (such as a SMO, or an AMO) and the gNB may add, for parameters of the multimedia service flow such as an XRM, an indication parameter configured for indicating activation and deactivation. The indication parameter may be used in an implicit or an explicit manner. The implicit manner may not define the parameter and may be used in the network element. For example, some indication bits may be reused. The explicit manner may use a new indication parameter for indication.

In some embodiments, based on the service flow periodicity being configured in a protocol data session establishment process or in a QoS flow parameter configuration process, if the periodicity is activated by default, a RAN side may configure a C-DRX period based on an end-to-end protocol data session and a QoS flow parameter, to implement power-saving transmission.

Operation 820: The AO/AS detects jitter distribution characteristic of the service data packet, and notifies the 5GC to deactivate the periodicity temporarily.

In some embodiments, the AO/AS may determine, by detecting a factor that affects periodicity of a pushing stream due to the computing power and the network condition in a transmission process of the service data packet, that the jitter distribution characteristic of the service data packet changes. For example, if detecting that a periodic change range of the service data packet is greater than a preset value, it is determined that there is jitter in periodic transmission of the service data packet. The periodicity information of the service data packet changes.

Operation 830: The 5GC network element notifies the gNB to deactivate the C-DRX configuration.

In some embodiments, based on receiving indication information (for example, the first indication information) sent by the AO/AS indicating that the periodicity is not stable, the 5GC network element may deactivate the periodicity with the gNB synchronously, for example, may change an indication bit in the indication parameter, and may not delete the periodicity parameter.

In addition, based on deactivating the C-DRX configuration, the gNB and UE suspend performing the C-DRX configuration and pushing a multimedia service flow such as the XRM based on the periodicity information. Based on the periodicity being deactivated, C-DRX transmission may be suspended, but a related CN and a related C-DRX parameter of a RAN node may not be deleted. The parameter may not be re-established in an activation process.

Operation 840: The AO/AS detects that the periodicity of the service data packet restores stability (or the periodicity is regained), and notifies the 5GC to activate the periodicity.

In some embodiments, based on detecting that a periodic change range of the service data packet is in a preset range, the AO/AS may determine that the periodicity information of the service data packet restores the stability (or the periodicity is regained), and may notify the 5GC to activate the periodicity.

Operation 850: The 5GC network element notifies the gNB to activate the C-DRX configuration.

In some embodiments, based on receiving indication information (for example, the second indication information) sent by the AO/AS that the periodicity restores the stability (or the periodicity is regained), the 5GC network element may activate the periodicity with the gNB synchronously, and the gNB and the UE continues to push the multimedia service flow such as the XRM based on the periodic C-DRX configuration.

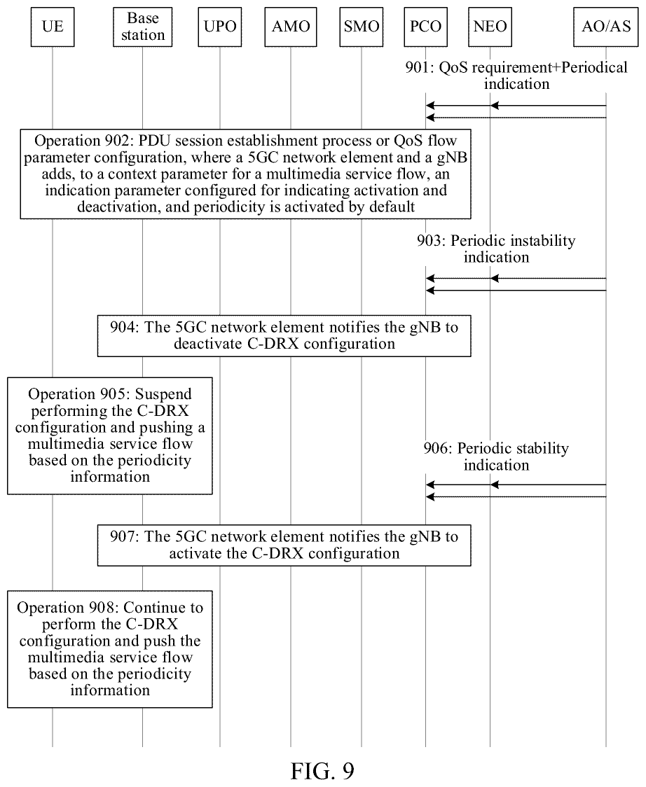

For an interaction process in FIG. 9, the process may include the following operations.

Operation 901: An AO/AS obtains service flow periodicity, and provides a periodicity indication and QoS condition to a PCO, for example, may directly send the periodicity indication and the QoS condition to the PCO, or send the periodicity indication and the QoS condition to an NEO, and the NEO forwards the periodicity indication and the QoS condition to the PCO.

Operation 902: Configure the service flow periodicity in a protocol data session establishment process or a QoS flow parameter configuration process, where a 5GC network element (such as a SMO, or an AMO) and a gNB may add, to a context parameter for a multimedia service flow such as an XRM, an indication parameter configured for indicating activation and deactivation. The indication parameter may be used in an implicit or an explicit manner.

In addition, the periodicity may be activated by default. In this situation, a RAN side may configure a C-DRX period based on an end-to-end protocol data session and a QoS flow parameter, to implement power-saving transmission.

Operation 903: The AO/AS detects that a period of the service data packet sends jitter, and notifies the 5GC to deactivate the periodicity temporarily, for example, may send a periodic instability indication to the PCO.

Operation 904: The 5GC network element notifies the gNB to deactivate the C-DRX configuration.

Based on receiving indication information sent by the AO/AS indicating that the periodicity is not stable, the PCO may deactivate the periodicity with the gNB synchronously, for example, may change an indication bit in the indication parameter, and may not delete the periodicity parameter.

Operation 905: Based on deactivating the C-DRX configuration, the gNB and UE suspend performing the C-DRX configuration and pushing the multimedia service flow such as the XRM based on the periodicity information.

Based on the periodicity being deactivated, C-DRX transmission is suspended, but a related CN and a related C-DRX parameter of a RAN node is not deleted. The parameter may not be re-established in an activation process.

Operation 906: The AO/AS detects that the periodicity of the service data packet restores stability (or the periodicity is regained), and notifies the 5GC to activate the periodicity, for example, may send a periodic stability indication (or an indication that the periodicity is regained) to the PCO.

Operation 907: The 5GC network element notifies the gNB to activate the C-DRX configuration.

In some embodiments, based on receiving indication information sent by the AO/AS that the periodicity restores the stability (or the indication that the periodicity is regained), the 5GC network element may activate the periodicity with the gNB synchronously.

Operation 908: The gNB and UE continue to perform the C-DRX configuration and push the multimedia service flow such as the XRM based on the periodicity information.

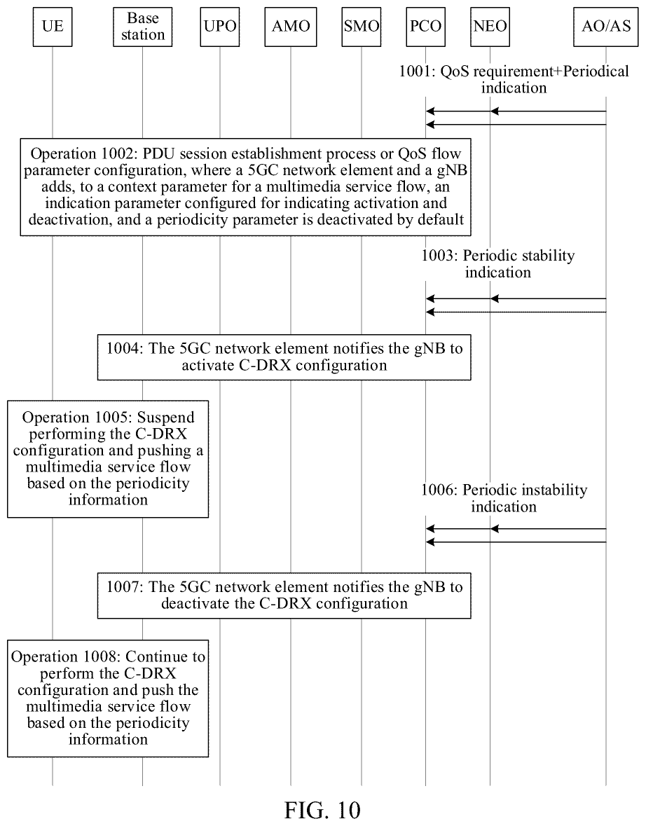

The interaction process in FIG. 9 illustrates the periodicity may be activated by default based on the periodicity parameter being configured. In some embodiments, the periodicity may not be activated by default. For details, refer to FIG. 10, and the following operations may be included.

Operation 1001: An AO/AS obtains service flow periodicity, and provides a periodicity indication and QoS condition to a PCO, for example, may directly send the periodicity indication and the QoS condition to the PCO, or send the periodicity indication and the QoS condition to an NEO, and the NEO forwards the periodicity indication and the QoS condition to the PCO.

Operation 1002: Configure the service flow periodicity in a protocol data session establishment process or a QoS flow parameter configuration process, where a 5GC network element (such as a SMO, or an AMO) and a gNB may add, to a context parameter for a multimedia service flow such as an XRM, an indication parameter configured for indicating activation and deactivation. The indication parameter may be used in an implicit or an explicit manner.

In addition, the periodicity may not be activated by default. In this situation, a RAN side may not configure a C-DRX period based on an end-to-end protocol data session and a QoS flow parameter, and may wait for activation.

Operation 1003: The AO/AS detects that the periodicity of the service data packet is stabile (or has the periodicity), and notifies the 5GC to activate the periodicity, for example, may send a periodic stability indication (or an indication having the periodicity) to the PCO.

Operation 1004: The 5GC network element notifies the gNB to activate the C-DRX configuration. In some embodiments, based on receiving indication information that is sent by the AO/AS and that the periodicity is stable (or the indication information having the periodicity), the 5GC network element may activate the periodicity with the gNB synchronously.

Operation 1005: The gNB and UE perform the C-DRX configuration and push the multimedia service flow such as the XRM based on the periodicity information.

Operation 1006: The AO/AS detects that a period of the service data packet sends jitter, and notifies the 5GC to deactivate the periodicity temporarily, for example, may send a periodic instability indication to the PCO.

Operation 1007: The 5GC network element notifies the gNB to deactivate the C-DRX configuration.

Based on receiving the indication information sent by the AO/AS indicating that the periodicity is not stable, the PCO may deactivate the periodicity with the gNB synchronously, for example, may change an indication bit in the indication parameter, and may not delete the periodicity parameter.

Operation 1008: Based on deactivating the C-DRX configuration, the gNB and UE suspend performing the C-DRX configuration and pushing the multimedia service flow such as the XRM based on the periodicity information.

Based on the periodicity being deactivated, C-DRX transmission may be suspended, but a related CN and a related C-DRX parameter of a RAN node may not be deleted. The parameter may not be re-established in an activation process.

The multimedia service may have the periodicity. The periodicity may be transferred from the AO to the 5GC as a reference for protocol data session establishment or QoS flow parameter configuration. For example, in a process of the protocol data session establishment or the QoS flow parameter configuration, the periodicity may be configured to the gNB. In addition, a factor that affects periodicity of a pushing stream due to the computing power and the network condition in the multimedia data stream transmission is considered, and the periodicity parameter configured for the gNB may be deactivated for partial period of time. During the deactivation, the periodicity parameter may be retained in a 5GC-related network element and the gNB, and a gNB side suspends to perform C-DRX configuration based on the periodicity. Based on detecting that the periodicity is stable (or the periodicity is regained), the AO/AS may activate the configured periodicity parameter, and continue to perform the C-DRX configuration. The periodicity of the service data packets may be stable in the C-DRX, and a QoS condition may be satisfied. This may improve service experience.

The following introduces some embodiments that may be used to execute the data transmission method according to some embodiments.

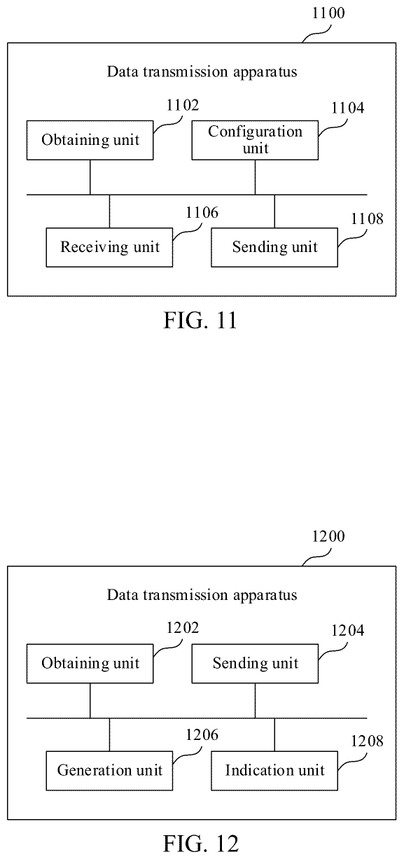

FIG. 11 is a block diagram of a data transmission apparatus according to some embodiments.

As shown in FIG. 11, a data transmission apparatus 1100 according to some embodiments includes an obtaining unit 1102, a configuration 1104, a receiving unit 1106, and a sending unit 1108.

The obtaining unit 1102 may be configured to receive periodicity information of a service data packet sent by an application object entity.

The configuration unit 1104 may be configured to configure the periodicity information of the service data packet for an access network-network element by using a configuration instruction.

The receiving unit 1106 may be configured to receive first indication information sent by the application object entity, where the first indication information may be configured for indicating that the periodicity information of the service data packet changes.

The sending unit 1108 may be configured to send deactivation information to the access network-network element, where the deactivation information may be configured for indicating the access network-network element to suspend scheduled transmission of the service data packet based on the periodicity information.

In some embodiments, the configuration unit 1104 may be configured to: generate a protocol data session establishment request, where the protocol data session establishment request includes the periodicity information of the service data packet; and

initiate a protocol data session establishment process based on the protocol data session establishment request, to configure the periodicity information of the service data packet to the access network-network element.

In some embodiments, the configuration unit 1104 may be configured to:

generate quality of service QoS flow configuration information, where the QoS flow configuration information includes the periodicity information of the service data packet; and

perform QoS flow configuration process based on the QoS flow configuration information, to configure the periodicity information of the service data packet for the access network-network element.

In some embodiments, the configuration instruction is further configured for instructing the access network-network element to directly perform scheduled transmission on the service data packet based on the periodicity information after receiving the configuration instruction.

In some embodiments, the configuration instruction is further configured for instructing the access network-network element to suspend the scheduled transmission of the service data packet based on the periodicity information after receiving the configuration instruction, and if not receiving activation information.

In some embodiments, the sending unit 1108 is further configured to:

if receiving second indication information sent by the application object entity after detecting that periodicity of the service data packet is stable, send the activation information to the access network-network element.

In some embodiments, based on sending the deactivation information to the access network-network element, the sending unit 1108 is further configured to: if second indication information sent by the application object entity based on detecting that the service data packet regains periodicity is received, send the activation information to the access network-network element, where the activation information may be configured for indicating the access network-network element to perform scheduled transmission on the service data packet based on the periodicity information.

In some embodiments, the configuration instruction includes an indication parameter, and the indication parameter may be configured to indicate to activate or deactivate the periodicity information of the service data packet.

In some embodiments, the indication parameter may be an explicitly indicated parameter or an implicitly indicated parameter.

In some embodiments, the deactivation information may be configured for modifying the indication parameter, so that the indication parameter indicates to deactivate the periodicity information solution the service data packet.

FIG. 12 is a block diagram of a data transmission apparatus according to some embodiments.

As shown in FIG. 12, a data transmission apparatus 1200 according to some embodiments includes an obtaining unit 1202, a send 1204, a generation unit 1206, and an indication unit 1208.

The obtaining unit 1202 may be configured to obtain periodicity information of a service data packet.

The sending unit 1204 may be configured to send the periodicity information of the service data packet to a core network-network element, so that the core network-network element configures the periodicity information of the service data packet for an access network-network element.

The generation unit 1206 may be configured to: if detecting that the periodicity information of the service data packet changes, generate first indication information.

The indication unit 1208 may be configured to send the first indication information to the core network-network element, so that the core network-network element sends deactivation information to the access network-network element, where the deactivation information may be configured for indicating the access network-network element to suspend scheduled transmission of the service data packet based on the periodicity information.

In some embodiments, the generation unit 1206 may be configured to:

if detecting that periodicity of the service data packet is stable or the service data packet the periodicity is regained, generate second indication information; and

send the second indication information to the core network-network element, so that the core network-network element sends activation information to the access network-network element, where the activation information may be configured for indicating the access network-network element to perform scheduled transmission on the service data packet based on the periodicity information.

According to some embodiments, each object, function, or unit may exist respectively or be combined into one or more units. Some objects, functions, or units may be further split into multiple smaller function subunits, thereby implementing the same operations without affecting the technical effects. The objects, functions, or units are divided based on logical functions. A function of one object, function, or unit may be realized by multiple units, or functions of multiple objects, functions, or units may be realized by one unit. In some embodiments, the apparatus may further include other objects, functions, or units. These functions may also be realized cooperatively by the other objects, functions, or units, and may be realized cooperatively by multiple objects, functions, or units.

A person skilled in the art would understand that these “objects,” “functions,” or “units” could be implemented by hardware logic, a processor or processors executing computer software code, or a combination of both. The “objects,” “functions,” or “units” may also be implemented in software stored in a memory of a computer or a non-transitory computer-readable medium, where the instructions of each unit are executable by a processor to thereby cause the processor to perform the respective operations of the corresponding unit.

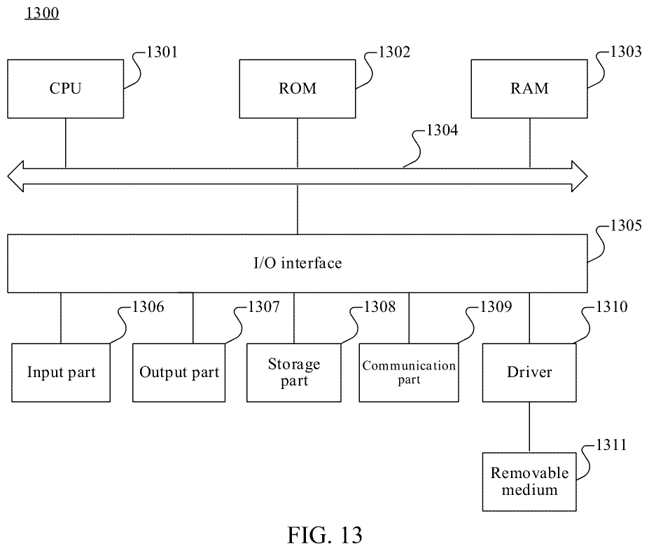

FIG. 13 is a schematic diagram of a structure of an electronic device according to some embodiments.

An electronic device 1300 as shown in FIG. 13 is an example, and the disclosure is not limited thereto.

As shown in FIG. 13, the electronic device 1300 includes a central processing unit (CPU) 1301, and the central processing unit may perform various appropriate actions and processes based on a program stored in a read-only memory (ROM) 1302 or a program loaded to a random access memory (RAM) 1303 from a storage part 1308, for example, perform the method according to some embodiments. Various programs and data for a system operation may be stored in the RAM 1303. The CPU 1301, the ROM 1302, and the RAM 1303 are connected through a bus 1304. An input/output (I/O) 1305 is connected to the bus 1304.

The following components are connected to the I/O interface 1305, including an input part 1306 of a keyboard, a mouse, and the like; including an input part 1307 of a cathode ray tube (CRT), a liquid crystal display (LCD), a speaker, and the like; including a storage part 1308 of hardware; and including a communication part 1309 of a network interface card such as a local area network (LAN) card, a modem, and the like. The communication part 1309 performs communication processing via a network such as the internet. A driver 1310 may be connected to the I/O interface 1305. A removable medium 1311, such as a magnetic disk, an optical disk, a magneto-optical disk, a semiconductor memory, and the like may be installed on the drive 1310, so that it may be read that a computer program may be installed to the storage part 1308.

Some embodiments described with reference to the flowchart may be implemented as a computer software program. For example, some embodiments include a computer program product, and the computer program product is carried on computer program of a computer-readable medium. The computer program includes a computer program configured to execute the method shown in the flowchart. In some embodiments, the computer program may be uploaded and installed from the network by using the communication part 1309, and/or be installed from the removable medium 1311. When the computer program is executed by the central processing unit (CPU) 1301, various functions are executed.

The computer-readable medium shown in some embodiments may be a computer-readable signal medium or a computer-readable storage medium, or any combination of the computer-readable signal medium and the computer-readable storage medium. The computer-readable storage medium may be, for example, but is not limited to, an electrical, magnetic, optical, electromagnetic, infrared, or a semiconductor system, apparatus or component, or any combination thereof. Examples of the computer-readable storage media may include, but are not limited to an electrical connection having one or more wires, a portable computer disk, a hard disk, a random access memory (RAM), a read-only memory (ROM), an erasable programmable read only memory (EPROM), a flash memory, fiber optics, a compact disc read-only memory (CD-ROM), an optical storage device, a magnetic storage device, or any appropriate combination thereof. The computer-readable storage medium may be any tangible medium that includes or stores a program. The program may be used by an instruction execution system, apparatus, or device, or may be used by a combination of the instruction execution system, apparatus, or device. However, the computer-readable signal medium may include a data signal propagated in a baseband or as a part of a carrier wave carrying the computer-readable computer program therein. The propagated data signal may use various forms, including but not limited to an electromagnetic signal, an optical signal, or any appropriate combination of thereof. The computer-readable signal medium may also be any computer-readable medium other than the computer-readable storage medium that may send, propagate, or transmit a program used by the instruction execution system, apparatus, or device, or used by the combination of the instruction execution system, apparatus, or device. The computer program included in the computer-readable media may be transmitted by using any appropriate medium, including but not limited to a wireless medium or a medium wired, or any appropriate combination of thereof.

Flowcharts and block diagrams in the drawings illustrate architectures, functions, and operations that may be implemented using the system, the method, and the computer program product according to various some embodiments. Each block in the flowchart or the block diagram may represent a module, a program segment, or a part of code. The module, the program segment, or the part of the code include one or more executable instructions for implementing logical functions. In some embodiments, the functions noted in the block may occur not in sequence noted in the drawings. For example, two blocks shown one after another may actually be executed in parallel, or the two blocks may be executed in a reverse order. This depends on the functions involved. Each box in the block diagram or the flowchart and a combination of boxes in the block diagram or the flowchart may be implemented may using a dedicated hardware-based system configured to execute a specified function or operation, or may be implemented by using a combination of dedicated hardware and the computer program.

The units involved in some embodiments may be implemented in software or may be implemented in hardware, and the described units may also be provided in a processor. Names of the units do not constitute a limitation on the unit.

Some embodiments provide a computer-readable medium. The computer-readable medium may be included in the electronic device described in embodiments, and may also exist alone without being assembled into the electronic device. The computer-readable medium carries one or more computer programs. When the one or more computer programs are executed by the electronic device, the electronic device implements the method described in some embodiments.

Some embodiments may be implemented by software, or may be implemented by software combined with hardware. Some embodiments may be implemented in a form of a software product. The software product may be stored in a non-volatile storage media (may be a CD-ROM, a USB flash disk, a hard disk, and the like) or on the network, including several instructions, so that a computer device (may be a personal computer, a server, a touch terminal, a network device, or the like) executes the method according to some embodiments.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in some embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A data transmission method, executed by an electronic device, comprising:
receiving periodicity information of a service data packet transmitted by an application object entity;
configuring the periodicity information for an access network-network element by using a configuration instruction;
receiving first indication information transmitted by the application object entity; and
transmitting deactivation information to the access network-network element,
wherein the first indication information indicates the periodicity information changes, and
wherein the deactivation information indicates the access network-network element is to suspend scheduled transmission of the service data packet based on the periodicity information.

2. The data transmission method according to claim 1, wherein the configuring the periodicity information comprises:
generating a protocol data session establishment request including the periodicity information; and
initiating a protocol data session based on the protocol data session establishment request, to configure the periodicity information for the access network-network element.

3. The data transmission method according to claim 1, wherein the configuring the periodicity information comprises:
generating quality of service QoS flow configuration information including the periodicity information; and
performing QoS flow configuration based on the QoS flow configuration information, to configure the periodicity information for the access network-network element.

4. The data transmission method according to claim 1, wherein the configuration instruction is further configured for instructing the access network-network element to directly perform the scheduled transmission of the service data packet based on the periodicity information after receiving the configuration instruction.

5. The data transmission method according to claim 1, wherein the configuration instruction is further configured for instructing the access network-network element to suspend the scheduled transmission of the service data packet based on:
the periodicity information after receiving the configuration instruction, and
not receiving activation information.

6. The data transmission method according to claim 5, further comprising:
based on receiving second indication information transmitted by the application object entity after detecting that periodicity of the service data packet is stable, transmitting the activation information to the access network-network element.

7. The data transmission method according to claim 1, further comprising:
based on receiving second indication information transmitted by the application object entity based on detecting that the service data packet regains periodicity, transmitting activation information to the access network-network element,
wherein the activation information indicates the access network-network element is to perform the scheduled transmission of the service data packet based on the periodicity information.

8. The data transmission method according to claim 1, wherein the configuration instruction includes an indication parameter indicating whether to activate or deactivate the periodicity information.

9. The data transmission method according to claim 8, wherein the indication parameter is at least one of an explicitly indicated parameter or an implicitly indicated parameter.

10. The data transmission method according to claim 8, wherein the deactivation information is configured for modifying the indication parameter, to enable the indication parameter to indicate to deactivate the periodicity information.

11. A data transmission apparatus, comprising:
at least one memory configured to store computer program code;
at least one processor configured to read the program code and operate as instructed by the program code, the program code comprising:
obtaining code configured to cause at least one of the at least one processor to receive periodicity information of a service data packet transmitted by an application object entity;
configuration code configured to cause at least one of the at least one processor to configure the periodicity information for an access network-network element by using a configuration instruction;
receiving code configured to cause at least one of the at least one processor to receive first indication information transmitted by the application object entity; and
transmitting code configured to cause at least one of the at least one processor to transmit deactivation information to the access network-network element,
wherein the first indication information indicates the periodicity information changes, and
wherein the deactivation indicates the access network-network element is to suspend scheduled transmission of the service data packet based on the periodicity information.

12. The data transmission apparatus according to claim 11, wherein the configuration code is configured to cause at least one of the at least one processor to:
generate a protocol data session establishment request including the periodicity information; and
initiate a protocol data session based on the protocol data session establishment request, to configure the periodicity information for the access network-network element.

13. The data transmission apparatus according to claim 11, wherein the configuration code is configured to cause at least one of the at least one processor to:
generate quality of service QoS flow configuration information including the periodicity information; and
perform QoS flow configuration based on the QoS flow configuration information, to configure the periodicity information for the access network-network element.

14. The data transmission method according to claim 11, wherein the configuration instruction is further configured for instructing the access network-network element to directly perform the scheduled transmission of the service data packet based on the periodicity information after receiving the configuration instruction.

15. The data transmission apparatus according to claim 11, wherein the configuration instruction is further configured for instructing the access network-network element to suspend the scheduled transmission of the service data packet based on:
the periodicity information after receiving the configuration instruction, and
if not receiving activation information.

16. The data transmission apparatus according to claim 12, wherein the transmitting code is further configured to cause at least one of the at least one processor to:
based on second indication information transmitted by the application object entity after detecting that periodicity of the service data packet is stable being received, transmit activation information to the access network-network element.

17. The data transmission apparatus according to claim 11, wherein the transmitting code is further configured to cause at least one of the at least one processor to:
based on second indication information transmitted by the application function entity based on detecting that the service data packet regains periodicity is received, transmit activation information to the access network-network element, and
wherein the activation information indicates the access network-network element is to perform the scheduled transmission on the service data packet based on the periodicity information.

18. The data transmission apparatus according to claim 11, wherein the configuration instruction comprises an indication parameter configured to indicate whether to activate or deactivate the periodicity information.

19. The data transmission apparatus according to claim 8, wherein the indication parameter is at least one of an explicitly indicated parameter or an implicitly indicated parameter.

20. A non-transitory computer-readable storage medium, storing computer code which, when executed by at least one processor, causes the at least one processor to at least:
receive periodicity information of a service data packet transmitted by an application object entity;
configure the periodicity information for an access network-network element by using a configuration instruction;
receive first indication information transmitted by the application object entity; and
transmit deactivation information to the access network-network element,
wherein the first indication information indicates the periodicity information changes, and
wherein the deactivation indicates the access network-network element is to suspend scheduled transmission of the service data packet based on the periodicity information.
